(19) United States
(12) Patent Application Publication
(10) Pub. No.: US 2015/0164190 A1
(43) Pub. Date: Jun. 18, 2015

(54) DECORATIVE ELEMENT FOR USE WITH PERSONAL ITEMS

(71) Applicants: Gennady Zaritsky, Brooklyn, NY (US); Mark Vais, Brooklyn, NY (US)

(72) Inventors: Gennady Zaritsky, Brooklyn, NY (US); Mark Vais, Brooklyn, NY (US)

(21) Appl. No.: 14/550,515

(22) Filed: Nov. 21, 2014

Related U.S. Application Data
(60) Provisional application No. 61/907,145, filed on Nov. 21, 2013.

(51) Int. Cl. A44C 27/00; B29C 35/02; A44C 25/00

(52) U.S. Cl. CPC A44C 27/00; A44C 25/007; B29C 35/02; B29L 2031/722

(57) ABSTRACT

The present invention is directed to a spherical device 100 is equipped with a central or para-central cavity 102, which passes through entire volume of the spherical device 100. In the illustrated configuration the central cavity 102 is circular in dimensions. However, those skilled in the art will recognize that other cavity configurations are applicable to the present invention. The spherical device 100 is further equipped with an opening 104 which extends from the poles of the spherical device to the central cavity to bisect one hemisphere of the spherical device 102. As a result, the spherical device 100 includes two faces 106 and 108 which are separated by the opening 104.

### CROSS-REFERENCE TO RELATED APPLICATION

The present application claims the benefit of U.S. Patent Application Ser. No. 61/907,145, filed Nov. 21, 2013, which is hereby incorporated by reference in its entirety.

### THE INVENTION

The present invention describes an apparatus for attaching a decorative element to articles and method for manufacturing the same. The described apparatus allows for the attachment of a variety of decorative accessories without the necessity of complicated and time consuming alterations to the article. The present invention is also directed to a method of constructing the described apparatus.

### BACKGROUND OF THE INVENTION

Currently there exist in the art many decorative charms. These decorative elements are used to customize or otherwise personalize components of personal attire. For example, it is known in the art to affix decorative elements to various personal electronic devices, hair care items, apparel and footwear.

However, the decorative elements found in the prior art suffer from numerous drawbacks relating to applicability, use, design and functionality. Specifically, the prior art suffers from a lack of usability as it applies to different apparel elements of varying sizes. For instance there exists in the prior art mechanisms for the attachment of decorative elements to headphone cables and the like. However, the prior art is limited by the lack of an attachment mechanism which is dynamic and allows for the secure attachment of the decorative element to a variety of different articles of apparel of varying dimensions. For example, the prior art is ill-suited for use with apparel items of varying diameter. For instance, Pending Published U.S. Patent Application No. 2009/0208049, herein incorporated by reference in its entirety, describes the use of head phone decorations, but fails to describe an invention with the ability to be adapted to different articles.

### SUMMARY OF THE INVENTION

The present invention overcomes the limitations of the prior art by providing an apparatus and method relating to decorative elements and their construction. The present invention advances the art by providing an apparatus configured and configurable to adapt to attach to various apparel items dynamically. As a result, the present invention is adaptable to a variety of different lines, wires, straps, laces chords and the like.

Additionally, the present invention is also directed to method of manufacturing decorative elements. For example, the present invention details the steps of manufacture and the process of printing decorative elements such that novelty or promotional features printed on the decorative element are displayed to the user. Likewise, the present invention is directed to process for applying sub-elements to the decorative element such that the functionality and appearance of the decorative element are altered with the addition of gems, jewels and the like.

### BRIEF DESCRIPTION OF THE DRAWINGS

The foregoing and other features described herein will be more readily apparent from the following detailed description and drawings of illustrative embodiments in which:

FIG. 1 is an illustrative perspective view of the apparatus of the present invention and described.

FIG. 2 is an illustrative top view of the apparatus of FIG. 1.

FIG. 3 is an illustrative side view of the apparatus of the present invention when engaged with an accessory element.

FIG. 4 is an illustrative diagram of the processing system described herein.

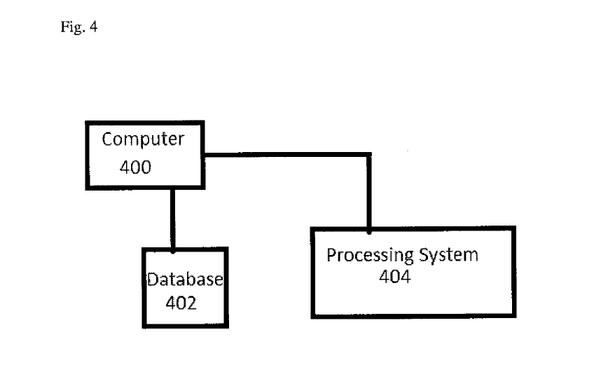

FIG. 5 is an alternative embodiment of the apparatus described herein.

FIG. 6 is a further view of the one embodiment of the apparatus described herein.

FIG. 7 is an alternative embodiment of the apparatus described herein.

### DESCRIPTION OF ILLUSTRATIVE EMBODIMENTS OF THE INVENTION

By way of overview and introduction, the present invention concerns an apparatus and method to secure decorative elements to accessories. In particular the present invention is directed to decorative elements used to decorate and style an accessory element. Those skilled in the art will recognize that accessory elements include, but are not limited to bracelets, erring, pendants, necklaces, bangles, rings, headphone and headphone wires, earphone and earphone wires, electronic plugs and the like, wires, strings, laces, cables, apparel, draw strings and tabs, hair pieces, clips, elastic headwear, shoe laces and other general apparel elements.

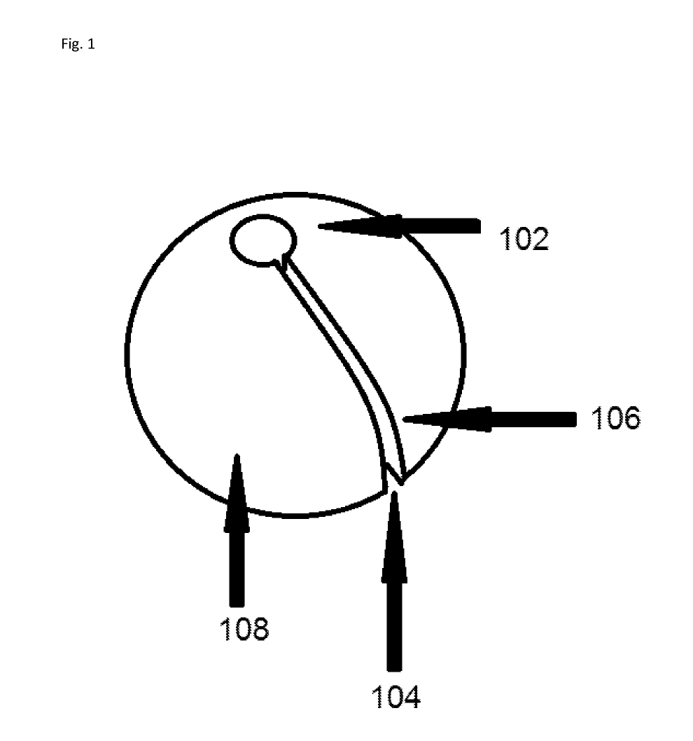

FIG. 1 illustrates the apparatus of the present invention. As shown, the decorative element is formed as a spherical device 100. In the foregoing discussion, and for the sake of ease of description, and in no way limiting the subject matter thereof, the spherical device 100 is formed of silicon rubber. However, those skilled in the art will recognize that other materials, naturally occurring or synthetic, treated or untreated are used in various arrangements of the invention. For example, materials such as natural or synthetic rubbers, composite materials or compounds, ceramic, metallic or multi-element structures are envisioned by the foregoing example.

Additionally, those skilled in the art will recognize that while the figures illustrate a spherical device 100, the present invention is in no way limited to a spherical geometry. The present invention can be configured in various geometries and configurations.

The spherical device 100 is equipped with a central or para-central cavity 102, which passes through entire volume of the spherical device 100. In alternative arrangements, the cavity is located in an alternative location. In the illustrated configuration the central cavity 102 is circular. However, those skilled in the art will recognize that other cavity configurations are applicable to the present invention. In the illustrated arrangement, the spherical device 100 is formed of a single piece of resilient material. However, in an alternative arrangement the spherical device 100 is formed of at least two materials joined or otherwise bonded together.

The spherical device 100 is further equipped with an opening slot 104 which extends from the poles of the spherical device to the central cavity and bisects one hemisphere of the spherical device 100. As a result, the spherical device 100 includes two faces 106 and 108 which are separated by the opening slot 104.

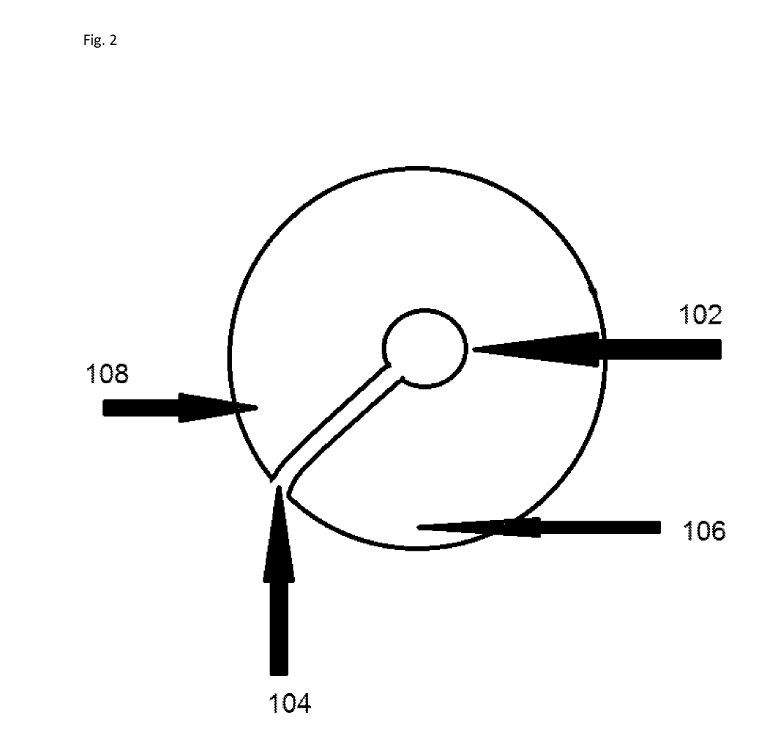

Without being bound by the dimensions recited herein, in the illustrated example the spherical device is 0.47 inches in diameter. The central cavity is configured to be 2.1 mm. These dimensions are merely for illustration purposes and are not critical values or ranges for the elements described herein. The dimensions of the opening are such that the existing resilient force inherent to the material in the given configuration is sufficient to obscure the opening to casual observation. For example, in the illustrated arrangement the opening 104 is configured such that the resilient nature of the silicon material forces the faces 106 and 108 to be in close proximity. In the alternative, the faces 106 and 108 are positioned in close proximity with one another, while maintaining an opening slot 104, as illustrated in FIG. 2.

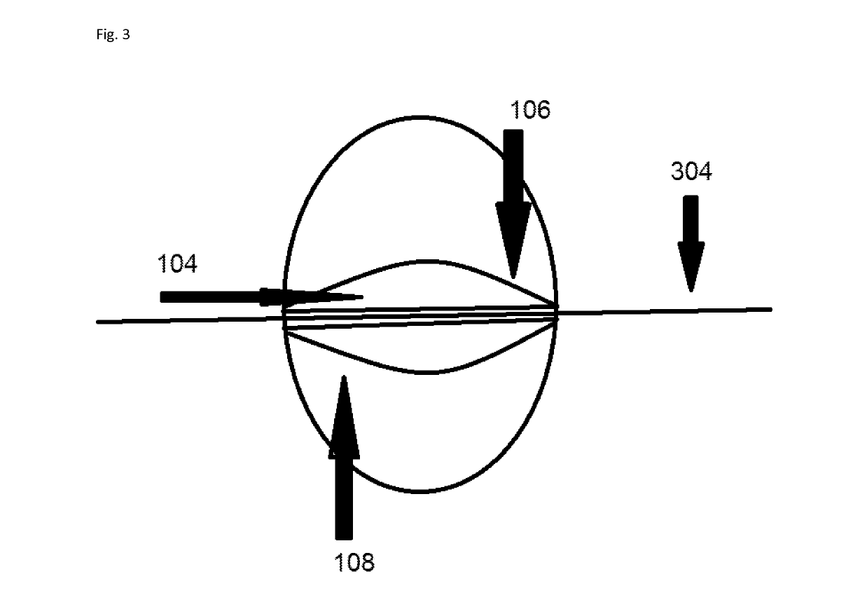

As illustrated in FIG. 3, the spherical device 100 is compressible by a user. Upon compression, the faces 106 and 108 are configured to move apart from one another, increasing the dimensions of the opening slot 104. Once the opening has reached a desired dimension, an accessory element 304, such as a wire or cord is inserted into the opening. Upon release or withdrawal of the compressive force on the spherical device 100, the resilient force of the material causes the accessory element to be secured within the central cavity 102. Once the spherical device 100 is secured to the accessory line 304, additional spherical devices can be affixed to the same or different accessories.

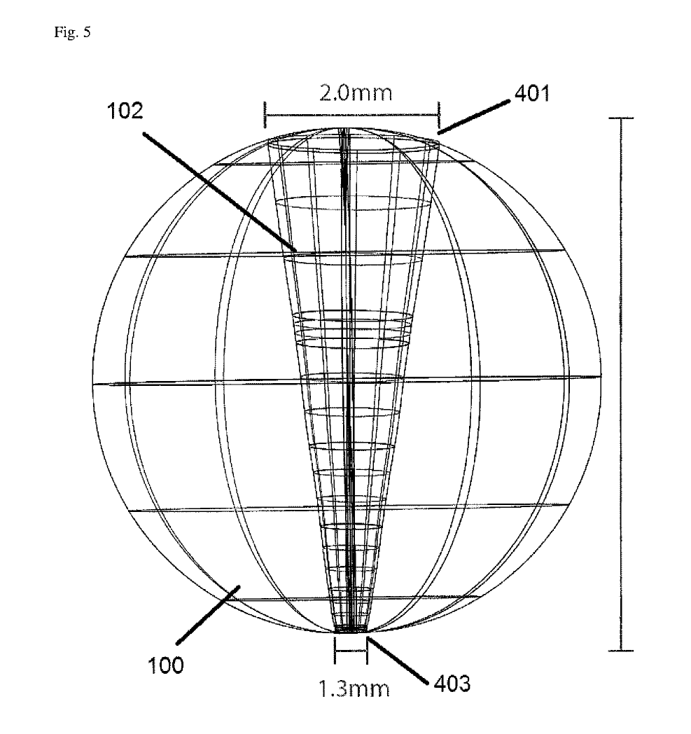

An alternative embodiment and configuration of the device described is provided in FIG. 5. As shown, the spherical device 100 is equipped with the central cavity 102. In the illustrated configuration, the poles of the spherical device have openings of different sizes. In the particular configuration, the spherical device 100 possesses a conical cavity that tapers from the first diameter to the second diameter. As shown, the first pole has an opening 401 having a diameter of 2.0 mm and a second pole has an opening having a diameter of 1.3 mm. However, those possessing an ordinary level of skill in the art will appreciate that the relative sizes and dimensions of the openings are modifiable based on the specific needs and applications of the user. In this arrangement, an accessory line (not shown) is inserted into the spherical device 100 using the opening slot 104 (not shown) that granting access to the central cavity.

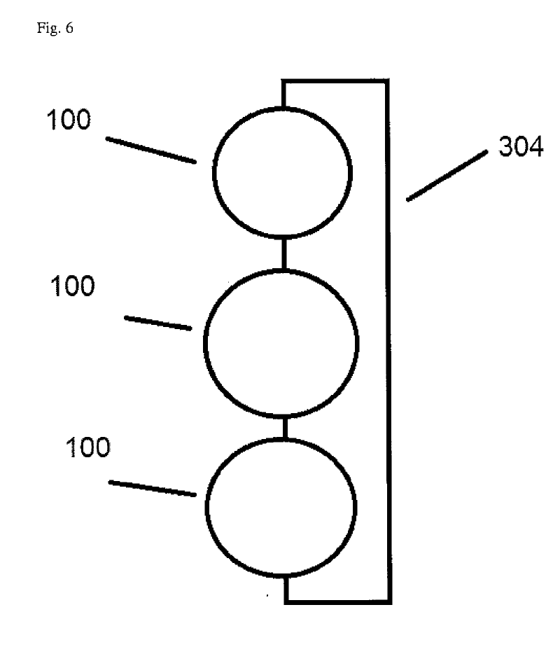

As shown in FIG. 6, the spherical devices 100 do not need to fit completely onto the accessory line 304. In one configuration, the compressive, or resilient force exerted by the hemispheres of the spherical device on the accessory line inserted into the opening slot 104 are sufficient to prevent the spherical devices 100 from being removed accidently or inadvertently. For—example, in one non-limiting arrangement, the coefficient of friction, or static friction, between the spherical device and the accessory line is at least 0.5. In an alternative configuration, the two faces 106 and 108 of the opposing hemispheres are equipped with a surface treatments or applications having a high coefficient of friction. In a further alternative configuration, the two faces (not shown) are textured, milled or otherwise prepared so that the surface of each face has an inherent coefficient of friction sufficient to resist or arrest the movement of the spherical device relative to the accessory line 304.

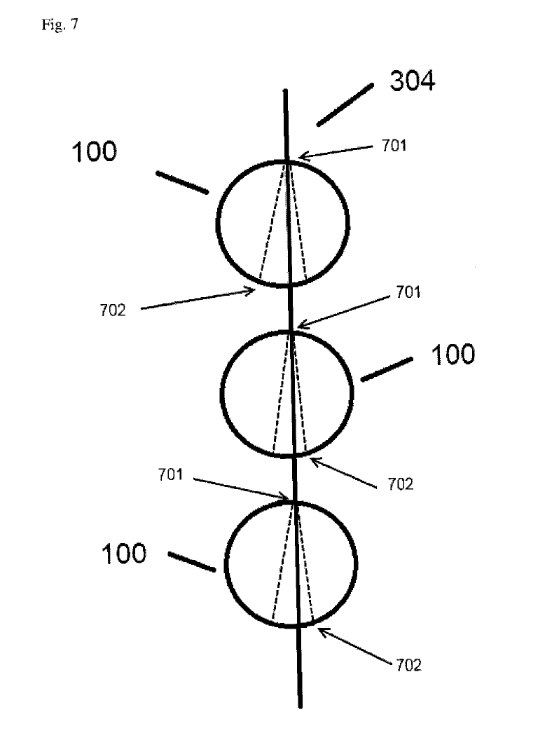

In yet a further arrangement illustrated in FIG. 7, the line accessory inserted into the spherical device 100 has a diameter or cross section that is smaller than the diameter of an opening at either pole. In the provided configuration, the accessory line has a larger cross-section than the diameter a first opening 701, but a smaller than the opposing opening 702. As shown, when the openings of the poles are of different diameters, a conical central cavity is formed, as shown in dashed lines.

In yet a further configuration, the line accessory has a diameter or cross section that is larger than the diameter of one opening to the central cavity but smaller than the diameter of the opposing pole.

The present invention also incorporates a method for attaching the apparatus described to apparel or other accessories. The method includes, without limitation, a step for dilating the opening in the spherical device by applying compressive force to the spherical device. A second step is provided for inserting an accessory element into the dilated opening of the spherical device. Third step is provided for closing the dilated opening by removing the compressive force.

The present invention also incorporates a method for manufacturing the apparatus described. Those skilled in the art will appreciate that those techniques existent in the art fail to generate spherical devices with the various elements and dimensions described. The present invention is directed to a method of manufacturing, an example of which is described with reference to silicon. In present invention includes steps for refining silicon. Those skilled in the art will recognize the various methods and techniques known in the art for the refinement of silicon which are applicable the present invention. A further step includes vulcanization of the refined silicon. Those skilled will appreciate the various techniques used to vulcanize refined silicon. A further step of is directed to finishing or processing the silicon. This step can include trimming the silicon and grinding the silicon.

A further step of includes molding the silicon, The molding step includes a sub-step for introducing the cavity into the spherical device. In one arrangement this introduction is accomplished after the formation of the spherical device. In an alternative step, the internal cavity is formed during the formation of the spherical device.

The method also includes a cutting step. The cutting step introduces the opening as shown in the illustrated figures. As described, the cutting step includes orientation of the cutting surface or spherical molded device such that the opening is formed between the polar positions of the spherical molded device. Furthermore, the cutting step further includes cutting sufficient material from the spherical molded device to form an opening, such that the opening will not be visible due to the compressive applied by the two side faces. The cutting step includes an optional further sub-step configured to align the cutting surface or head such that the silicon is not compromised or otherwise deformed or degraded, such that a further processing or finishing step is not needed.

The present invention envisions a further step of printing onto the surface of the spherical device after the opening has been formed. In the process described, the images and material printed to the spherical device are orientated with respect to the opening such that they are on the opposite hemisphere to the hemisphere bisected by the opening cut into the spherical material. In the alternative, the printing can cover the spherical device from one face continuously to the other face, but not spanning the opening.

The printing step further includes a sub-step of heating the spherical device and applying ink to the spherical device. In a specific example, the ink applied is environmental glossy high temperature printing ink. In a further arrangement, the method includes a printing sub-step with includes printing the spherical device in one direction. In a further arrangement the ink is applied to the spherical device such that only a single color is needed to construct a two color image. In this arrangement, the spherical device is of a particular color, tone or hue, and the ink is of a different color, tone or hue. In the alternative a multi-color image is applied to the spherical device.

In the alternative to the printing step, the present invention includes an application step. In this arrangement, small sub-accessories are applied to the surface of the spherical device. For example in one arrangement, crystal elements are applied to the surface of the spherical device. In one configuration, the sub-step includes measuring the spherical device and determining the dimensions and quantity of the sub-applications necessary to cover the surface, with exception of the opening, of the spherical device with sub-applications. In one arrangement, the process also includes the application of a plurality of glue or adhesive layers to the surface of the spherical device prior to application of the sub-accessories. A further step includes allowing the glue to naturally cure over time.

The above processing functions can operate as a series of programmed steps performed by a properly configured computer system using one or more modules of computer-executable code to instruct various physical devices and appliances. For instance, a set of software modules can be configured to cooperate with one another to provide instructions to a cutting device so that accurate positioning and orientation of the opening is obtained. Furthermore, a further module could be provided such that the dimensions of the opening made during the cutting step are dynamically calculated based on the cutting device and the spherical material and other properties.

Each of these modules can comprise hardware, code executing in a computer, or both, that configure a machine such as the computing system 400 to implement the functionality described herein. For instance, the computer 400 is configured to obtain data from a database 402 relative to each of the processing steps and implement them in a process device 404 properly configured to manufacture the decorative elements. The process device is configured as a series of discreet instruments used in the manufacture of the spherical devices or a complete system for the production of the entire spherical device. The functionality of these modules can be combined or further separated, as understood by persons of ordinary skill in the art, in analogous implementations of embodiments of the invention.

While this specification contains many specific implementation details, these should not be construed as limitations on the scope of any implementation or of what can be claimed, but rather as descriptions of features that can be specific to particular embodiments of particular implementations. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous.

Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing can be advantageous.

What is claimed:

1. An apparatus for attaching decorative elements to items, comprising:
a spherical device having an opening at a first pole and at a second pole, the spherical device having a central cavity extending from the first pole to the second pole;
the spherical device further equipped with an opening which extends from the first pole to the second pole of the spherical device, so as to bisect one hemisphere of the spherical device and defining a first hemisphere surface and a second hemisphere surface.

2. The apparatus of claim 1, wherein the spherical device is formed of a single piece of resilient material.

3. The apparatus of claim 1, wherein the spherical device is formed of at least two pieces of resilient material.

4. The apparatus of claim 1, wherein the first opening has a diameter that is larger than the diameter of the second opening.

5. The apparatus of claim 1, wherein the coefficient of friction between the spherical device and the accessory line is at least 0.5.

6. The apparatus of claim 5, wherein the material of the spherical device is treated so as to increase the coefficient of friction of the material.

7. A system for attaching decorative elements to items, comprising:
a spherical device having an opening at a first pole and at a second pole, the spherical device having a central cavity extending from the first pole to the second pole;
the spherical device further equipped with an opening which extends from the first pole to the second pole of the spherical device, so as to bisect one hemisphere of the spherical device and defining a first hemisphere surface and a second hemisphere surface; and
an accessory device configured to inserted in the opening located between he first and second surfaces.

8. The apparatus of claim 6, wherein the a compressive force is exerted on the accessory line by the first and second hemisphere surfaces, such compressive force sufficient to prevent movement of the spherical device over the line.

9. A method for manufacturing decorative elements comprising the steps of
a. forming a suitable material in a mold, into a spherical shape;
b. introducing a central cavity into the material spanning the diameter of the spherical shape;
c. removing a portion of the material from a hemisphere of the spherical material so as to provide an opening allowing access to the central cavity.

10. The method of claim 9, further including the steps of generating a first end of the central cavity having a first diameter, and generating a second end of the central cavity having a second diameter.
